(19) United States
(12) Patent Application Publication
(10) Pub. No.: US 2004/0050445 A1
(43) Pub. Date: Mar. 18, 2004

(54) Steel pipe having low yield ratio

(76) Inventors: Masahiro Ohgami, Kitakyushu-shi (JP); Toshio Fujii, Hikari-shi (JP); Toshiyuki Ogata, Hikari-shi (JP); Hiroyuki Mimura, Hikari-shi (JP)

Correspondence Address: BAKER & BOTTS, 30 ROCKEFELLER PLAZA, NEW YORK, NY, 10112

(21) Appl. No.: 10/617,239

(22) Filed: Jul. 10, 2003

(30) Foreign Application Priority Data
Jul. 10, 2002 (JP) 2002-200797(PAT.)

(51) Int. Cl. F16L 9/00

(52) U.S. Cl. 138/177

(57) ABSTRACT

A steel pipe having a low yield ratio is provided. The steel pipe may contain, in mass, 0.01% to 0.20% C, 0.05% to 1.0% Si, 0.1% to 2.0% Mn and 0.001% to 0.05% Al, the microstructure of the steel pipe is composed of ferrite and pearlite, or ferrite and cementite, and the average size of the ferrite grains is at least 20 μm. The steel pipe may also contain, in mass, 0.03% to 0.20% C, 0.05% to 1.0% Si, 0.1% to 2.0% Mn, 0.001% to 0.05% Al, 0.01% to 0.5% Nb and 0.001% to 0.01% N, with the microstructure of the steel pipe being composed of ferrite and bainite, or ferrite, martensite and bainite, or ferrite and martensite.

### CROSS-REFERENCE TO RELATED APPLICATIONS

The present application claims priority under 35 U.S.C. § 119 from Japanese Patent Application No. 2002-200797 filed on Jul. 10, 2002, the entire disclosure of which is incorporated herein by reference.

### FIELD OF THE INVENTION

The present invention relates to a steel pipe having a low yield ratio.

### BACKGROUND INFORMATION

It may be effective to use a steel material having a low yield ratio, as a structural member, to enhance the earthquake resistance of a building. In that sense, a steel pipe for a building should have a low yield ratio. This is because it is estimated that if the yield ratio of a steel pipe for a building is lower, the steel pipe may seldom rupture, even though it yields. Therefore the structure is less likely to be destroyed.

In the case of a line pipe, highly reliable impact resistance and earthquake resistance are preferable for a line pipe to avoid the leakage of a transported material such as petroleum or the bursting of the line pipe. In that sense, it may be effective to use a steel pipe having a low yield ratio as a line pipe for greater safety.

With regard to a welded steel pipe, as such pipe undergoes the influence of cold-working such as bending, pipe expansion, drawing, etc. during a pipe production, the welded steel pipe having the same low yield ratio as the steel sheet used as the mother material of the steel pipe may not be obtained, in many cases. Therefore, to obtain a steel pipe having a low yield ratio, it is preferable to sufficiently lower the yield ratio of a steel sheet before it is used in pipe production.

Japanese Patent Publication No. H10-17980 describes that, in the event of producing a welded steel pipe having a low yield ratio, steel containing 1 to 3% Cr as an essential component may be used as the base steel and the structure of the steel is composed of a composite structure containing a soft ferrite phase and a hard bainite or martensite phase in a conventional manner. According to the disclosure of this publication, Cr should be not less than 1% as an essential component in order to secure a low yield ratio and a high strength simultaneously by forming a hard phase composed of a bainite phase or a martensite phase. However, it would not be possible to provide a low cost steel pipe having a low yield ratio because Cr alloy is expensive. In addition, Cr tends to form oxides during welding and when Cr oxides remain at a weld-butting portion, the quality of a weld deteriorates.

Japanese Patent Publication No. 2000-54061 describes that a steel material and a steel pipe made of the steel material, that have a low yield ratio at the ordinary temperature and are excellent in strength at a high temperature, can be obtained by controlling the C contained in the steel material to not more than 0.03%, preferably not more than 0.015%, making Nb exist in the state of solid solution and, further, appropriately controlling the microstructure of the steel material. Japanese Patent Publication No. 2000-239972 describes that a steel material and a steel pipe made of the steel material, that have a low yield ratio at the ordinary temperature and are excellent in strength at a high temperature, can be obtained by controlling the C contained in the steel material to not more than 0.02%, preferably not more than 0.015%, and adding Nb and Sn abundantly. However, according to the disclosures of these publications, a low yield ratio is secured by limiting the upper limit of C to not more than 0.03% and 0.02%, respectively, preferably not more than 0.015%, and, by so doing, reducing the amount of solute C at the ordinary temperature. However, in such cases of reducing the C amount as described above, a high tensile strength is seldom obtained in a tensile test at the ordinary temperature.

The entire disclosures of the referenced publications/documents are incorporated herein by reference.

### SUMMARY OF THE INVENTION

One of the objects of the present invention is to provide a steel pipe having a low yield ratio. Accordingly, a steel pipe having a low yield ratio pursuant to one exemplary embodiment of the present invention which contains, in mass, 0.01 to 0.20% C, 0.05 to 1.0% Si, 0.1 to 2.0% Mn and 0.001 to 0.05% Al, with the balance consisting of Fe and unavoidable impurities. The microstructure of the steel pipe may be composed of ferrite and additionally one or both of pearlite and cementite. The average size of the ferrite grains is preferably not smaller than 20 μm. The microstructure of the steel pipe may contain spheroidized pearlite or spheroidized cementite. The average size of pearlite grains or cementite crystal grains may be preferably not greater than 20 μm. In addition, the steel pipe may contain, in mass, one or both of 0.01 to 0.5% Nb and 0.001 to 0.01% N.

According to another exemplary embodiment of the present invention, the steel pipe having a low yield ratio is provided which contains, in mass, 0.03 to 0.20% C, 0.05 to 1.0% Si, 0.1 to 2.0% Mn, 0.001 to 0.05% Al, 0.01 to 0.5% Nb and 0.001 to 0.01% N, with the balance consisting of Fe and unavoidable impurities. The microstructure of the steel pipe can be composed of ferrite and bainite, and the average size of the ferrite grains may be at least 20 μm. The content rate of bainite may be, in a volume fraction, between 1% and 15%.

In yet another exemplary embodiment of the present invention, a steel pipe having a low yield ratio is provided which contains, in mass, 0.03 to 0.20% C, 0.05 to 1.0% Si, 0.1 to 2.0% Mn, 0.001 to 0.05% Al, 0.01 to 0.5% Nb and 0.001 to 0.01% N, with the balance consisting of Fe and unavoidable impurities. The microstructure of the steel pipe may be composed of ferrite, martensite and bainite, or ferrite and martensite, and the average size of the ferrite grains may be at least 20 im. The content rate of bainite may be, in volume fraction, between 1% and 15%, and/or that of martensite may be, in volume fraction, between 1% and 15%.

It is also possible that the steel pipe may contain, in mass, one or both of 0.005 to 0.1% Ti and 0.0001 to 0.005% B. In another variant of the present invention, the steel pipe can contain, in mass, one or more of 0.01 to 0.5% V, 0.01 to 1% Cu, 0.01 to 1% Ni, 0.01 to 1% Cr and 0.01 to 1% Mo.

### DETAILED DESCRIPTION OF THE EXEMPLARY EMBODIMENT(S)

According to an exemplary embodiment of the present invention, the microstructure of a steel pipe is preferably composed of a structure containing ferrite and the average size of the ferrite grains may be at least 20 μm. As a yield stress is proportioned to (grain size)^{1/2} according to Hall-Petch's Law, a yield stress and a yield ratio increase as a grain size decreases. In contrast, a yield stress and a yield ratio decrease as a grain size increases. When the average size of ferrite grains contained in a microstructure is at least 20 μm, a yield stress lowers and as a result a low yield ratio can be obtained even with a steel pipe after subjected to pipe production processes. An average size of ferrite grains is preferably not smaller than 30 μm, still preferably not smaller than 40 μm.

The average size of grains including ferrite grains is measured in accordance with the method described in the Appendix 1 of JIS G 0552 standard. In the case of martensite or bainite, the size of prior austenite grains is measured and it is recommended to conform to the Appendix 3 of JIS G 0551 standard.

It is preferable that the content rate of ferrite in a microstructure is in the range from 70% to 98%. This is because, when the content rate of ferrite is less than 70%, a yield stress may not be lowered sufficiently even with a ferrite grain size increased and therefore a low yield ratio would likely not be obtained. However, when the content rate of ferrite exceeds 98%, the tensile strength of a steel lowers, and therefore a low yield ratio may not be obtained likewise. It is still preferable that the content rate of ferrite is in the range from 75% to 95%.

The content rate of ferrite, bainite or martensite in a microstructure according to the present invention may be inductive of a volume traction of ferrite, bainite or martensite in the microstructure, respectively.

In a conventional hot rolling procedure of a steel sheet used for producing a steel pipe having a low yield ratio, the steel sheet is rolled in the temperature range from a temperature of the γ phase region to a lower side temperature of the two-phase region after it is heated to a temperature of the γ phase region. Therefore, it is unlikely, and maybe impossible to make the average ferrite grain size at least 20 μm using such conventional procedure. One of the principles of the present enables to finish rolling in the temperature range from a temperature of the γ phase region to a higher side temperature of the two-phase region after a steel is heated to a temperature of the γ phase region, thus suppressing the fractionalization of grains. As a result, a steel having an average ferrite grain size of at least 20 μm may be produced.

It is possible to make the average ferrite grain size at least 20 μm by controlling a cooling rate to not more than 10° C./sec. up to the temperature of the Ar₁ point+50° C. after the end of hot rolling. Furthermore, it is possible to make the average ferrite grain size be at least 30 or even 40 μm by controlling a temperature at the end of hot rolling, a cooling rate after the end of hot rolling, etc.

According to one exemplary embodiment of the present invention, a microstructure can be composed of ferrite and additionally one or both of pearlite and cementite. According to a second exemplary embodiment of the present invention, the microstructure may be composed of ferrite and bainite. According to a third exemplary embodiment of the present invention, the microstructure can be composed of ferrite, martensite and bainite, or ferrite and martensite. Each such exemplary embodiment of the present invention is described in further detail herein below.

### First Exemplary Embodiment

According to the first exemplary embodiment of the present invention, the microstructure is preferably composed of ferrite and additionally one or both of pearlite and cementite. Thus, such microstructure contains ferrite as an preferable phase and additionally one or both of pearlite and cementite. As a result of composing this structure, a steel pipe having a low yield ratio and a tensile strength of 500 MPa to 600 MPa can be produced.

The reasons for limiting the chemical components in the first exemplary embodiment of the present invention are as follow.

C is an element that precipitates as solid solution or carbides in a matrix and enhances the strength of a steel. Further, C precipitates also as the second phase composed of cementite and pearlite. Therefore, in the event of forming a hot-rolled steel sheet into a steel pipe by cold forming, C suppresses the increase of a yield stress or proof stress, enhances tensile strength and uniform elongation, and resultantly contributes to the lowering of a yield ratio. C is preferable to be contained at least 0.01%, preferably not less than 0.04%, for securing the effect of cementite, etc. precipitating as the second phase on the lowering of a yield ratio. However, when C is contained in excess of 0.20%, the effect of lowering a yield ratio and weldability likely deteriorate. For these reasons, a C content may be limited to the range from 0.01% to 0.20%.

Si functions as a deoxidizer and enhances the strength of a steel by dissolving in a matrix. The effect appears with a Si content of at least 0.05%. On the other hand, when Si exceeds 1.0%, the effect of lowering a yield ratio may deteriorate. For these reasons, the Si content can be limited to the range from 0.05% to 1.0%.

Mn is an element that enhances the strength of a steel and accelerates the precipitation of cementite or pearlite composing the second phase. The effects appear with a Mn content of not less than 0.1%. On the other hand, when Mn is contained in excess of 2.0%, the effect of lowering a yield ratio may deteriorate. For these reasons, the Mn content can be limited to the range from 0.1% to 2.0%. Here, from the viewpoint of strength and toughness, it is preferable that the Mn content is in the range from 0.3% to 1.5%.

Al is used as a deoxidizer but the amount of Al significantly influences a grain size and mechanical properties. An Al content of less than 0.001% is insufficient as a deoxidizer. On the other hand, when Al exceeds 0.05%, oxides containing Al increase in a steel and can deteriorate toughness. For these reasons, the Al content may be limited to the range from 0.001% to 0.05%.

A microstructure composed of ferrite and additionally one or both of pearlite and cementite according to the first invention is obtained by: finishing rolling in the temperature range from a temperature of the γ phase region to a higher side temperature of the γ-α two-phase region after a steel is heated to a temperature of the γ phase region. Thereafter, cooling the steel at a cooling rate of not more than 10° C./sec. up to the temperature of the Ar₁ point+50° C.; and successively cooling the steel at a cooling rate of not less than 3° C./sec. in the temperature range not higher than the temperature of the Ar₁ point+50° C.

It is preferable that the microstructure further contains spheroidized pearlite or spheroidized cementite. This is because, when such a structure is contained, the increase of a yield ratio can be suppressed in the event of forming a steel sheet into a steel pipe. In addition, spheroidized pearlite or spheroidized cementite has the effect of improving uniform elongation. It can be determined whether pearlite or cementite is spheroidized or not by defining pearlite or cementite as it is spheroidized when an aspect ratio between the length and the width of the second phase is not more than 2 in a section parallel with the rolling direction.

The spheroidization of pearlite or cementite can be done by: (i) heating a steel material to a temperature in the range of 1,150° C.±50° C., (ii) thereafter finishing the hot rolling of the steel material at a temperature of not lower than the Ar₁ point and thus producing a steel strip about 10 mm in thickness to which strain (dislocation) is introduced, (iii) successively cooling the steel strip at a cooling rate of 3 to 30° C./sec. up to a temperature of not higher than 700° C., (iv) then coiling it, and, in the meantime, (v) precipitating cementite or pearlite at grain boundaries or on dislocations.

Further, it is preferable that the average size of pearlite grains or cementite grains is not larger than 20 μm. The reason is that, by so doing, the increase of a yield ratio can be suppressed in the event of forming a steel sheet into a steel pipe. An average pearlite grain size of not larger than 20 μm can be obtained by controlling the cooling rate to at least 3° C./sec. in the temperature range not higher than the temperature of the Ar₁ point+50° C. after the end of hot rolling.

In addition, it is preferable that the steel pipe contains one or both of 0.01% to 0.5% Nb and 0.001% to 0.01% N. Nb is an element that precipitates as solid solution or carbonitrides in a matrix and enhances strength, and therefore Nb is preferably used to be contained by at least 0.01%. However, even though Nb is excessively added in excess of 0.5%, the effect is saturated and a sufficient strengthening effect is not secured or, instead, precipitates coarsen and toughness deteriorates. For these reasons, a Nb content is limited to the range from 0.01% to 0.5%. N exists as solid solution or nitrides in a matrix. A N content of not less than 0.001% is preferable for forming nitrides that contribute to the strengthening of a steel. However, when N is added in excess of 0.01%, coarse nitrides tend to form and may deteriorate toughness. For these reasons, the N content can be limited to the range from 0.001% to 0.01%.

### Second Exemplary Embodiment

According to the second exemplary embodiment of the present invention, the microstructure is composed of ferrite and bainite. As a result of composing such structure, a steel pipe having a low yield ratio and a tensile strength of 600 MPa to 700 MPa can be produced.

The reasons for limiting the chemical components in the second invention are as follows.

C is an element that precipitates as solid solution or carbides in a matrix and enhances the strength of a steel. C is preferable to be contained by not less than 0.03% because the strength in a steel material of a heavy thickness is insufficient with the content of less than 0.03%, preferably C is requited to be contained by not at least 0.05%. However, when C is contained in excess of 0.20%, weldability deteriorates. For these reasons, a C content may be limited to the range from 0.03% to 0.20%.

Si functions as a deoxidizer and enhances the strength of a steel by dissolving in a matrix. The effect appears with a Si content of at least 0.05%. On the other hand, when Si exceeds 1.0%, the toughness of a steel material may deteriorate. For these reasons, the Si content is limited to the range from 0.05% to 1.0%.

Mn is an element that enhances the strength of a steel and the effect appears with a Mn content of not less than 0.1%. A preferable content of Mn is at least 0.3%. However, when Mn is contained in excess of 2.0%, toughness may deteriorate caused by center segregation. For these reasons, the Mn content may be limited to the range from 0.1% to 2.0%. Here, from the viewpoint of strength and toughness, it is preferable that the Mn content is in the range from 0.3% to 1.5%.

Al is used as a deoxidizer but the amount of Al significantly influences a grain size and mechanical properties. An Al content of less than 0.001% may be insufficient as a deoxidizer. On the other hand, when Al can exceed 0.05%, oxides containing Al increase in a steel and deteriorate toughness. For these reasons, the Al content may be limited to the range from 0.001% to 0.05%.

Nb is an element that precipitates as solid solution or carbonitrides in a matrix and enhances strength, and therefore Nb is preferable to be contained by at least 0.01%. However, even though Nb is excessively added in excess of 0.5%, the effect is saturated and a sufficient strengthening effect is not secured, or instead, precipitates coarsen and toughness may deteriorate. For these reasons, a Nb content may be limited to the range from 0.01% to 0.5%.

N exists as solid solution or nitrides in a matrix. A N content of not less than 0.001% is preferable for forming nitrides that contribute to the strengthening of a steel. However, when N is added in excess of 0.01%, coarse nitrides tend to form and may deteriorate toughness. For these reasons, the N content may be limited to the range from 0.001% to 0.01%.

The microstructure containing bainite according to the second exemplary embodiment of the present invention can be obtained by: (i) heating a steel material to a temperature in the range of 1,150° C.±100° C., (ii) thereafter hot rolling the steel material into a steel strip about 10 mm in thickness, (iii) then cooling the steel strip at a cooling rate of not more than 10° C./sec. up to the temperature of the Ar₁ point+50° C. and thus causing ferrite transformation, (iv) successively cooling the steel strip at a cooling rate of not less than 5° C./sec. in the temperature range not higher than the temperature of the Ar₁ point+50° C. and thus forming bainite, and (v) coiling the steel strip in the temperature range of not higher than 600° C.

It is preferable that the content rate of bainite is in the range from 1% to 15%. This is because, in a composite structure of ferrite and bainite, though the effect of lowering the increment of a yield ratio (YR) appears during the forming of the steel pipe when a bainite content rate is in the range from 1% to 15%, the effect does not appear with a bainite content rate of less than 1% and the YR increases with a bainite content rate of more than 15%. For these reasons, the content rate of bainite may be limited to the range from 1% to 15%.

A bainite content rate in the range from 1% to 15% can be obtained by controlling the cooling rates up to the temperature of the Ar₁ point+50° C. and in the temperature range not higher than the temperature of the Ar₁ point+50° C. to the aforementioned conditions. If the cooling rates deviate from the aforementioned conditions, a bainite content rate rises or pearlite comes to be contained abundantly.

Possibly a very small amount of pearlite or cementite may be contained in a composite structure of ferrite and bainite as far as the amount is in the range where the effect of lowering the increment of a yield ratio during the forming of a steel pipe is not hindered.

Further, it is preferable that the average size of bainite grains is in the range from 1 μm to 20 μm. Due to such range, the increment of a yield ratio during the forming of a steel pipe can be lowered.

### Third Exemplary Embodiment

According to the third exemplary embodiment of the present invention, the microstructure is composed of ferrite, martensite and bainite, or ferrite and martensite. As a result of composing such a structure, a steel pipe having a low yield ratio and a tensile strength of 700 MPa to 800 MPa can be produced.

The reasons for limiting the chemical components in the third invention are as follows.

C is an element preferable for precipitating as solid solution or carbides in a matrix and thus securing strength; and forming a hard phase of bainite and martensite and thus securing a low yield ratio. When a C content is less than 0.03%, a hard phase of bainite and martensite is not formed and thus a low yield ratio may not be not secured. Therefore, the C content not less than 0.03% is preferable. A preferable content thereof is at least 0.05%. However, when C is contained in excess of 0.20%, weldability and toughness may deteriorate. For these reasons, the C content can be limited to the range from 0.03% to 0.20%.

Si functions as a deoxidizer and enhances the strength of a steel by dissolving in a matrix. The effect appears with a Si content of at least 0.05%. On the other hand, when Si exceeds 1.0%, the toughness of a steel material may deteriorate. For these reasons, the Si content is limited to the range from 0.05% to 1.0%.

Mn is an element that enhances the strength of a steel and the effect appears with a Mn content of at least 0.1%. A preferable content of Mn is at least 0.3%. However, when Mn is contained in excess of 2.0%, toughness may deteriorate caused by center segregation. For these reasons, the Mn content is limited to the range from 0.1% to 2.0%. Here, from the viewpoint of strength and toughness, it is preferable that the Mn content is in the range from 0.3% to 1.5%.

Al is used as a deoxidizer but the amount of Al significantly influences a grain size and mechanical properties. An Al content of less than 0.001% is insufficient as a deoxidizer. On the other hand, when Al exceeds 0.05%, oxides containing Al increase in a steel and may deteriorate toughness. For these reasons, the Al content may be limited to the range from 0.001% to 0.05%.

Nb is an element that precipitates as solid solution or carbonitrides in a matrix and enhances strength, and therefore Nb is preferable to be contained by at least 0.01%. However, even though Nb is excessively added in excess of 0.5%, the effect is saturated and a sufficient strengthening effect is not secured or, instead, precipitates coarsen and toughness may deteriorate. For these reasons, a Nb content can be limited to the range from 0.01% to 0.5%.

N exists as solid solution or nitrides in a matrix. A N content of not less than 0.001% is preferable for forming nitrides that contribute to the strengthening of a steel. However, when N is added in excess of 0.01%, coarse nitrides tend to form and deteriorate toughness. For these reasons, the N content can be limited to the range from 0.001% to 0.01%.

The microstructure composed of ferrite, martensite and bainite, or ferrite and martensite according to the third exemplary embodiment of the present invention may be obtained by: (i) heating a steel material to a temperature in the range of 1,150° C.±100° C., (ii) thereafter hot rolling the steel material into a steel strip about 10 mm in thickness and finishing the hot rolling at a temperature of not lower than the Ar₃ point, (iii) then cooling the steel strip at a cooling rate of not more than 10° C./sec. up to the temperature of the Ar₁ point+50° C. and thus causing ferrite transformation, (iv) successively cooling the steel strip at a cooling rate of not less than 10° C./sec. up to a temperature of not higher than 600° C., preferably 500° C., still preferably 450° C., in the temperature range not higher than the temperature of the Ar₁ point+50° C. and thus forming bainite and/or martensite, and (v) coiling the steel strip.

According to this embodiment, it is preferable that the content rate of bainite is in the range from 1% to 15% and/or the content rate of martensite is in the range from 1% to 15%. The reason is that, in a composite structure of ferrite and bainite and/or martensite, though the effect of lowering the increment of a yield ratio appears during the forming of a steel pipe when the content rate of bainite is in the range from 1% to 15% and/or the content rate of martensite is in the range from 1% to 15%, the effect does not appear with a bainite or martensite content rate of less than 1% and the YR increases with a bainite or martensite content rate of more than 15%. For these reasons, the content rate of bainite and/or that of martensite may be limited to the range from 1% to 15%, respectively.

A bainite and/or martensite content rate in the range from 1% to 15% can be obtained by controlling the cooling rates up to the temperature of the Ar₁ point+50° C. and in the temperature range not higher than the temperature of the Ar₁ point+50° C. to the aforementioned conditions. If the cooling rates deviate from the aforementioned conditions, a bainite or martensite content rate rises or pearlite comes to be contained abundantly.

Exemplary reasons for limiting the preferable chemical components common to the first, second and third exemplary embodiments of the present inventions are described below.

Ti is an element that has the effect of improving weldability and the effect is recognized with a Ti content of at least 0.005%. However, when Ti is added in excess of 0.1%, the deterioration of workability and an unnecessary increase of strength are caused by the increase of Ti carbonitrides. For these reasons, the Ti content may be limited to the range from 0.005% to 0.1%.

B may cause grain boundary strengthening and precipitation strengthening by precipitating in the forms of M₂₃(C, B)₆, etc. and thus increases strength. The effect is low with a B content of less than 0.0001%. On the other hand, when the B content exceeds 0.005%, the effect is saturated, a coarse B-contained phase tends to form, and enbrittlement is likely to occur. For these reasons, the B content can be limited to the range from 0.0001% to 0.005%.

V increases strength as a precipitation-strengthening element. The effect is insufficient with a V content of less than 0.01%. On the other hand, when a V content exceeds 0.5%, not only carbonitrides coarsen but also the increment of yield strength increases. For these reasons, the V content may be limited to the range from 0.01% to 0.5%.

Cu is an element that increases strength. When a Cu content is less than 0.01%, the effect is low. On the other hand, when Cu is added in excess of 1%, the increment of yield strength increases. For these reasons, the Cu content may be limited to the range from 0.01% to 1%.

Ni is an element that increases strength and also is effective for improving toughness. When a Ni content is less than 0.01%, the effect of improving toughness is low. On the other hand, when Ni is added in excess of 1%, the increment of yield strength increases. For these reasons, the Ni content may be limited to the range from 0.01% to 1%.

Cr increases strength as a precipitation-strengthening element. The effect is insufficient with a Cr content of less than 0.01%. On the other hand, when the Cr content exceeds 1%, not only carbonitrides coarsen but also the increment of yield strength increases. For these reasons, the Cr content may be limited to the range from 0.01% to 1%.

Mo causes solid solution strengthening and at the same time increases strength. When a Mo content is less than 0.01%, the effect is low. On the other hand, when Mo is added in excess of 1%, the increment of yield strength increases. For these reasons, the Mo content may be limited to the range from 0.01% to 1%.

A steel according to the present invention can be provided in the forms of not only a steel pipe produced by cold-forming a hot-rolled steel sheet but also a steel plate and a steel sheet. Further, as an example of a product produced by cold-working a steel according to the present invention, an electric resistance welded steel pipe is nominated. With regard to the effects of the exemplary embodiments of the present invention, the effect of lowering a yield ratio is prominent when a low strain pipe forming method can be employed.

### EXAMPLES

### Example 1 Which Relates to the First Exemplary Embodiment

Steels having the components shown in Table 1 were produced into continuously cast slabs and then the slabs were hot rolled into steel sheets 10 mm in thickness. In the hot-rolling process, (i) the slabs were heated to a temperature of 1,150° C., (ii) thereafter, the hot rolling were finished at a temperature of 900° C. (Ar₁ point+170° C.) and thus strain (dislocation) were introduced, (iii) successively, the steel sheets were cooled at the cooling rates in the range from 5 to 15° C./sec. up to a temperature of not higher than 700° C., and then (iv) the steel sheets were coiled.

The microstructures of the steel sheets are shown in Table 2. The tensile properties of a steel sheet were evaluated by using an as-rolled specimen of the steel sheet to which no working was applied and a specimen thereof to which 5%-prestrain was applied. 5%-prestrain corresponds to the cold-working applied for forming a steel sheet 10 mm in thickness into a steel pipe 200 mm in diameter. In general, prestrain is applied so as to equal the value of t (steel pipe thickness)/D (steel pipe diameter) with respect to a steel pipe to be produced. The prestrain was given by the method wherein a tensile test specimen was pulled with a tensile tester and the pulling was stopped at the time when the strain reached 5%. The tensile properties evaluated were YS (yield strength), TS (tensile strength) and YR (yield ratio). The results of the evaluation are shown in Table 2.

TABLE 1

| | | Chemical components (mass %) | | | | | | | | | | | |
|---|---|---|---|---|---|---|---|---|---|---|---|---|---|
| | Symbol | C | Si | Mn | Al | Cu | Ni | Cr | Mo | V | Nb | Ti | B |
| Invention | A-1 | 0.15 | 0.25 | 1.30 | 0.023 | 0.005 | 0.006 | 0.004 | 0.006 | 0.005 | 0.004 | 0.002 | 0.00005 |
| example | B-1 | 0.14 | 0.35 | 1.25 | 0.030 | 0.004 | 0.005 | 0.005 | 0.004 | 0.007 | 0.005 | 0.003 | 0.00006 |
| | C-1 | 0.12 | 0.31 | 1.12 | 0.025 | 0.006 | 0.007 | 0.006 | 0.005 | 0.006 | 0.006 | 0.001 | 0.00007 |
| | D-1 | 0.12 | 0.28 | 1.08 | 0.020 | 0.005 | 0.005 | 0.004 | 0.004 | 0.005 | 0.006 | 0.003 | 0.00005 |
| | E-1 | 0.08 | 0.41 | 0.85 | 0.019 | 0.007 | 0.006 | 0.005 | 0.005 | 0.004 | 0.004 | 0.012 | 0.00150 |
| | F-1 | 0.13 | 0.32 | 0.72 | 0.025 | 0.005 | 0.020 | 0.410 | 0.560 | 0.303 | 0.071 | 0.001 | 0.00005 |
| | G-1 | 0.07 | 0.34 | 0.80 | 0.036 | 0.540 | 0.650 | 0.005 | 0.005 | 0.215 | 0.056 | 0.020 | 0.00210 |
| Comparative | H-1 | 0.005 | 0.11 | 0.55 | 0.018 | 0.005 | 0.004 | 0.003 | 0.005 | 0.004 | 1.575 | 0.001 | 0.00005 |
| example | I-1 | 0.32 | 0.05 | 0.62 | 0.022 | 0.004 | 1.640 | 0.004 | 0.004 | 0.005 | 0.003 | 0.002 | 0.00004 |
| | J-1 | 0.05 | 0.005 | 0.48 | 0.034 | 0.006 | 0.004 | 0.005 | 0.005 | 0.984 | 0.005 | 0.003 | 0.00005 |
| | K-1 | 0.17 | 1.65 | 0.22 | 0.027 | 0.003 | 0.006 | 2.130 | 0.006 | 0.005 | 0.004 | 0.002 | 0.00006 |
| | L-1 | 0.11 | 0.32 | 0.06 | 0.035 | 0.004 | 0.005 | 0.006 | 2.572 | 0.004 | 0.006 | 0.001 | 0.00004 |
| | M-1 | 0.10 | 0.21 | 3.14 | 0.041 | 1.520 | 0.003 | 0.007 | 0.004 | 0.006 | 0.004 | 0.003 | 0.00003 |
| | N-1 | 0.12 | 0.45 | 1.57 | 0.005 | 0.005 | 0.007 | 0.005 | 0.006 | 0.005 | 0.006 | 0.002 | 0.01025 |
| | O-1 | 0.14 | 0.15 | 1.25 | 0.120 | 0.004 | 0.005 | 0.005 | 0.004 | 0.004 | 0.005 | 0.534 | 0.00004 |

TABLE 2

| | | Microstructure | | | | | | | | |
|---|---|---|---|---|---|---|---|---|---|---|
| | | | Cementite or pearlite | | Tensile properties | | | | | |
| | | Average ferrite grain | | Average | As-rolled specimen | | | 5%-prestrain specimen | | |
| | | size | Spheroidized | grain size | YS | TS | YR | YS | TS | YR |
| | Symbol | (μm) | or not | (μm) | (MPa) | (MPa) | (%) | (MPa) | (MPa) | (%) |
| Invention | A-1 | 50 | 0 | 23 | 304 | 511 | 60 | 541 | 610 | 89 |
| example | B-1 | 41 | 1 | 10 | 281 | 506 | 55 | 423 | 558 | 76 |
| | C-1 | 48 | 0 | 18 | 278 | 479 | 58 | 492 | 570 | 86 |
| | D-1 | 54 | 1 | 9 | 254 | 475 | 53 | 388 | 523 | 74 |
| | E-1 | 68 | 0 | 19 | 250 | 438 | 57 | 467 | 530 | 88 |
| | F-1 | 45 | 0 | 18 | 283 | 518 | 55 | 497 | 609 | 82 |
| | G-1 | 25 | 1 | 4 | 240 | 436 | 55 | 334 | 470 | 71 |
| Comparative | H-1 | 33 | 0 | 25 | 130 | 325 | 40 | 398 | 425 | 94 |
| example | I-1 | 30 | 0 | 31 | 344 | 564 | 61 | 648 | 673 | 96 |
| | J-1 | 17 | 0 | 38 | 130 | 350 | 37 | 425 | 468 | 91 |
| | K-1 | 24 | 0 | 35 | 418 | 571 | 73 | 668 | 685 | 97 |
| | L-1 | 18 | 0 | 11 | 261 | 409 | 64 | 465 | 484 | 96 |
| | M-1 | 17 | 0 | 32 | 321 | 479 | 67 | 567 | 589 | 96 |
| | N-1 | 84 | 0 | 44 | 254 | 470 | 54 | 586 | 595 | 98 |
| | O-1 | 10 | 0 | 5 | 336 | 452 | 74 | 477 | 509 | 94 |

Spheroidized or not
0: Not spheroidized
1: Spheroidized

In the cases of the invention examples Symbols A-1 to G-1, the steel components were within the ranges specified in the present invention and any of the average ferrite grain sizes was not smaller than 20 μm. The yield ratios (YRs) of the 5%-prestrain specimens were in the range from 71 to 89%. In the cases of Symbols B-1, D-1 and G-1 wherein pearlite or cementite was spheroidized, the YRs of the 5%-prestrain specimens were lower than the other specimens.

In the cases of the comparative examples Symbols H-1 to O-1, any of the steel components deviated from the ranges specified in the present invention. The average ferrite grain sizes were smaller than 20 μm in the cases of Symbols J-1, L-1, M-1 and O-1. These were the examples wherein YRs increased because YSs increased after 5%-prestrain was imposed. There were no cases where cementite or pearlite was spheroidized and, in the cases of Symbols H-1 to K-1, M-1 and N-1, the average grain sizes of the cementite or pearlite were outside the preferable range of not larger than 20 μm. These were the examples wherein pearlite or cementite that composed the second phase grew larger because the cooling rates were less than 3° C./sec. in the temperature range of not higher than Ar₁ point+50° C. after the end of hot rolling. Here, the yield ratios (YRs) of the 5%-prestrain specimens were in the range from 91 to 98%. These were the examples wherein YSs increased and thus YRs increased because the grain sizes of cementite or pearlite that composed the second phase were large and therefore the cementite or pearlite grains acted as resistance to deformation when 5%-prestrain was imposed.

### Example 2 Which Relates to the Second Exemplary Embodiment

Steels having the components shown in Table 3 were produced into continuously cast slabs and then the slabs were hot rolled into steel sheets 10 mm in thickness. In the hot-rolling process: the slabs were heated to a temperature of 1,150° C.; thereafter the hot rolling was finished at a temperature of 900° C. (Ar₁ point+170° C.); the steel sheets were cooled at the cooling rate of 5° C./sec. up to a temperature of 780° C. (Ar₁ point+50° C.) and thus ferrite transformation was caused; successively the steel sheets were cooled at the cooling rate of 20° C./sec. in the temperature range of not higher than 780° C. (Ar₁ point+50° C.) and thus bainite was formed; and then the steel sheets were coiled in the temperature range from 500° C. to 600° C.

The microstructures of the steel sheets are shown in Table 4. The tensile properties of a steel sheet were evaluated by using an as-rolled specimen of the steel sheet to which no working was applied and a specimen thereof to which 5%-prestrain was applied. 5%-n prestrain corresponds to the cold-working applied for forming a steel sheet 10 mm in thickness into a steel pipe 200 mm in diameter.

In general, prestrain may be applied so as to equal the valve of t (steel pipe thickness)/D (steel pipe diameter) with respect to a steel pipe to be produced. The method of imposing prestrain and the conditions of the tensile tests were the same as Example 1. The results of the evaluation are shown in Table 4.

TABLE 3

| | | Chemical components (mass %) | | | | | | | | | | | | |
|---|---|---|---|---|---|---|---|---|---|---|---|---|---|---|
| | Symbol | C | Si | Mn | Al | Nb | N | Cu | Ni | Cr | Mo | V | Ti | B |
| Invention | A-2 | 0.07 | 0.22 | 1.12 | 0.018 | 0.021 | 0.0024 | 0.003 | 0.004 | 0.004 | 0.006 | 0.005 | 0.002 | 0.00005 |
| example | B-2 | 0.13 | 0.31 | 1.05 | 0.024 | 0.052 | 0.0030 | 0.005 | 0.001 | 0.005 | 0.004 | 0.007 | 0.003 | 0.00006 |
| | D-2 | 0.11 | 0.24 | 0.94 | 0.021 | 0.031 | 0.0020 | 0.001 | 0.006 | 0.004 | 0.004 | 0.005 | 0.012 | 0.00153 |
| | E-2 | 0.15 | 0.42 | 0.83 | 0.015 | 0.027 | 0.0030 | 0.123 | 0.534 | 0.004 | 0.006 | 0.004 | 0.012 | 0.00004 |
| | F-2 | 0.11 | 0.38 | 0.75 | 0.027 | 0.034 | 0.0030 | 0.003 | 0.001 | 0.564 | 0.671 | 0.214 | 0.015 | 0.00027 |
| Comparative | H-2 | 0.005 | 0.12 | 0.45 | 0.023 | 1.575 | 0.0030 | 0.003 | 0.001 | 0.002 | 0.004 | 0.003 | 0.002 | 0.00004 |
| example | I-2 | 0.39 | 0.08 | 0.52 | 0.031 | 0.002 | 0.0020 | 0.005 | 1.684 | 0.003 | 0.005 | 0.004 | 0.003 | 0.00030 |
| | J-2 | 0.04 | 0.005 | 1.24 | 0.018 | 0.005 | 0.0158 | 0.002 | 0.003 | 0.007 | 0.003 | 0.875 | 0.002 | 0.00005 |
| | K-2 | 0.14 | 1.58 | 0.53 | 0.024 | 0.004 | 0.0020 | 0.006 | 0.004 | 2.260 | 0.006 | 0.003 | 0.001 | 0.00003 |
| | L-2 | 0.10 | 0.28 | 0.05 | 0.017 | 0.006 | 0.0050 | 0.001 | 0.005 | 0.004 | 2.395 | 0.004 | 0.003 | 0.00002 |
| | M-2 | 0.12 | 0.32 | 2.78 | 0.042 | 0.004 | 0.0030 | 1.640 | 0.007 | 0.005 | 0.003 | 0.005 | 0.002 | 0.00005 |
| | N-2 | 0.11 | 0.52 | 1.48 | 0.004 | 0.006 | 0.0040 | 0.003 | 0.006 | 0.003 | 0.005 | 0.004 | 0.001 | 0.01058 |
| | O-2 | 0.05 | 0.23 | 0.85 | 0.115 | 0.005 | 0.0050 | 0.004 | 0.002 | 0.002 | 0.002 | 0.003 | 0.456 | 0.00004 |

TABLE 4

| | | Metallographic structure | | | Tensile properties | | | | | |
|---|---|---|---|---|---|---|---|---|---|---|
| | | | Average ferrite | Bainite | As-rolled specimen | | | 5%-prestrain specimen | | |
| | | Structure | grain size | content rate | YS | TS | YR | YS | TS | YR |
| | Symbol | composition | (μm) | (volume %) | (MPa) | (MPa) | (%) | (MPa) | (MPa) | (%) |
| Invention | A-2 | α + B | 46 | 0 | 311 | 440 | 71 | 369 | 468 | 79 |
| example | B-2 | α + B | 35 | 13 | 413 | 585 | 71 | 476 | 634 | 75 |
| | D-2 | α + B | 38 | 12 | 381 | 540 | 70 | 442 | 589 | 75 |
| | E-2 | α + B | 82 | 4 | 399 | 553 | 72 | 462 | 602 | 77 |
| | F-2 | α + B | 41 | 10 | 406 | 608 | 67 | 469 | 657 | 71 |
| Comparative | H-2 | α + P | 13 | 0 | 245 | 310 | 79 | 304 | 326 | 93 |
| example | I-2 | α + B | 31 | 51 | 811 | 1119 | 72 | 1177 | 1293 | 91 |
| | J-2 | α + P | 58 | 0 | 279 | 354 | 79 | 346 | 372 | 93 |
| | K-2 | α + B | 33 | 38 | 704 | 959 | 73 | 919 | 987 | 93 |
| | L-2 | α + P | 10 | 0 | 395 | 562 | 70 | 530 | 592 | 90 |
| | M-2 | α + B | 32 | 29 | 708 | 877 | 81 | 868 | 903 | 96 |
| | N-2 | α + B | 94 | 42 | 564 | 809 | 70 | 762 | 833 | 92 |
| | O-2 | α + P | 8 | 0 | 303 | 375 | 81 | 369 | 392 | 94 |

α: Ferrite
B: Bainite
P: Pearlite

In the cases of Symbols A-2 to F-2, the steel components were within the ranges specified in the present invention, any of the structures was composed of ferrite and bainite, any of the average ferrite grain sizes was not smaller than 20 μm, and the content rates of bainite were in the preferable range of not more than 15%. The yield ratios (YRs) of the 5%-prestrain specimens were in the range from 71% to 79%. In the cases where the content rates of bainite were high, though both YSs and TSs increased after 5%-prestrain was imposed, the increment of YSs was small in comparison with that of TSs and therefore YRs in those cases were lower than YRs in the cases where the content rates of bainite were low.

In the cases of the comparative examples Symbols H-2 to O-2, any of the steel components deviated from the ranges specified in the present invention. In the cases of Symbols H-2, J-2, L-2 and O-2, the crystal structures were composed of ferrite and pearlite. Pearlite was formed since the cooling rates were less than 5° C./sec. in the temperature range of not higher than Ar₁ point+50° C. In the cases of Symbols H-2, L-2 and O-2, the average ferrite grain sizes were less than 20 μm. This meant that the average ferrite grain sizes reduced because the cooling rates were more than 10° C./sec. up to a temperature of Ar₁ point+50° C. after the end of hot rolling. In any cases of Symbols I-2, K-2, M-2 and N-2 where the structures were composed of ferrite and bainite, the content rates of bainite exceeded 15%; the upper limit of the preferable range. This was because the cooling after the end of hot rolling was commenced from a temperature higher than Ar₁ point+50° C. and, as a result, ferrite transformation did not proceed and thus the content rates of bainite increased. The yield ratios (YRs) of the 5%-prestrain specimens were in the range from 90 to 96%. YSs and TSs were higher in the cases of high bainite content rates than in the cases of low bainite content rates.

### Example 3 Which Relates to the Third Exemplary Embodiment

Steels having the components shown in Table 5 were produced into continuously cast slabs and then the slabs were hot rolled into steel sheets 10 mm in thickness. In the hot-rolling process: the slabs were heated to a temperature of 1,150° C.; thereafter the hot rolling was finished at a temperature of 900° C. (Ar₁ point+170° C.); the steel sheets were cooled at the cooling rate of 5° C./sec. up to a temperature of 780° C. (Ar₁ point+50° C.) and thus ferrite transformation was caused; successively the steel sheets were cooled at the cooling rate of 30° C./sec. in the temperature range of not higher than 780° C. (Ar₁ point+50° C.) and thus bainite and/or martensite were/was formed; and then the steel sheets were coiled in the temperature range from 400° C. to 500° C.

The microstructures of the steel sheets are shown in Table 6. The tensile properties of a steel sheet were evaluated by using an as-rolled specimen of the steel sheet to which no working was applied and a specimen thereof to which 5%-prestrain was applied. 5%-prestrain corresponds to the cold-working applied for forming a steel sheet 10 mm in thickness into a steel pipe 200 mm in diameter. In general, prestrain is applied so as to equal the value of t (steel pipe thickness)/D (steel pipe diameter) with respect to a steel pipe to be produced. The prestrain was given by the method wherein a tensile test specimen was pulled with a tensile tester and the pulling was stopped at the time when the strain reached 5%. The conditions of the tensile tests were the same as Example 1. The results of the evaluation are shown in Table 6.

TABLE 5

| | | Chemical components (mass %) | | | | | | | | | | | | |
|---|---|---|---|---|---|---|---|---|---|---|---|---|---|---|
| | Symbol | C | Si | Mn | Al | Nb | N | Cu | Ni | Cr | Mo | V | Ti | B |
| Invention | A-3 | 0.08 | 0.21 | 1.21 | 0.021 | 0.035 | 0.0032 | 0.001 | 0.002 | 0.004 | 0.003 | 0.004 | 0.003 | 0.00007 |
| example | B-3 | 0.12 | 0.33 | 0.95 | 0.026 | 0.051 | 0.0024 | 0.003 | 0.001 | 0.005 | 0.004 | 0.006 | 0.002 | 0.00005 |
| | D-3 | 0.10 | 0.41 | 0.72 | 0.018 | 0.045 | 0.0051 | 0.002 | 0.005 | 0.004 | 0.002 | 0.003 | 0.015 | 0.00176 |
| | E-3 | 0.15 | 0.52 | 0.83 | 0.028 | 0.053 | 0.0023 | 0.104 | 0.512 | 0.003 | 0.002 | 0.005 | 0.013 | 0.00005 |
| | F-3 | 0.11 | 0.37 | 0.76 | 0.032 | 0.072 | 0.0041 | 0.005 | 0.004 | 0.587 | 0.573 | 0.225 | 0.015 | 0.00027 |
| Comparative | H-3 | 0.005 | 0.12 | 0.45 | 0.023 | 1.575 | 0.0030 | 0.003 | 0.001 | 0.002 | 0.004 | 0.003 | 0.002 | 0.00004 |
| example | I-3 | 0.42 | 0.15 | 0.48 | 0.048 | 0.003 | 0.0025 | 0.001 | 1.463 | 0.002 | 0.004 | 0.003 | 0.002 | 0.00003 |
| | J-3 | 0.27 | 0.003 | 1.24 | 0.018 | 0.005 | 0.0158 | 0.002 | 0.003 | 0.007 | 0.003 | 0.875 | 0.002 | 0.00005 |
| | K-3 | 0.10 | 1.48 | 1.85 | 0.024 | 0.001 | 0.0018 | 0.002 | 0.001 | 2.534 | 0.002 | 0.001 | 0.001 | 0.00005 |
| | L-3 | 0.11 | 0.32 | 0.04 | 0.017 | 0.005 | 0.0035 | 0.001 | 0.004 | 0.003 | 2.438 | 0.002 | 0.002 | 0.00003 |
| | M-3 | 0.13 | 0.27 | 2.58 | 0.042 | 0.003 | 0.0051 | 1.845 | 0.006 | 0.001 | 0.002 | 0.003 | 0.003 | 0.00006 |
| | N-3 | 0.12 | 0.45 | 1.52 | 0.004 | 0.004 | 0.0046 | 0.002 | 0.005 | 0.003 | 0.004 | 0.004 | 0.005 | 0.01432 |
| | O-3 | 0.04 | 0.31 | 0.93 | 0.115 | 0.006 | 0.0024 | 0.001 | 0.001 | 0.004 | 0.001 | 0.005 | 0.367 | 0.00008 |

TABLE 6

| | | Metallographic structure | | | | Tensile properties | | | | | |
|---|---|---|---|---|---|---|---|---|---|---|---|
| | | | Average | Bainite | | | | | Specimen corresponding | | |
| | | | ferrite | content | Martensite | As-rolled specimen | | | to t/D = 5% | | |
| | | Structure | grain size | rate | content rate | YS | TS | YR | YS | TS | YR |
| | Symbol | composition | (μm) | (volume %) | (volume %) | (MPa) | (MPa) | (%) | (MPa) | (MPa) | (%) |
| Invention | A-3 | α + M | 46 | 0 | 7 | 409 | 507 | 81 | 498 | 581 | 86 |
| example | B-3 | α + B + M | 35 | 7 | 9 | 491 | 635 | 77 | 611 | 716 | 85 |
| | D-3 | α + B + M | 38 | 6 | 8 | 455 | 582 | 78 | 561 | 660 | 85 |
| | E-3 | α + B + M | 82 | 10 | 13 | 593 | 782 | 76 | 751 | 870 | 86 |
| | F-3 | α + B + M | 41 | 11 | 13 | 564 | 775 | 73 | 717 | 862 | 83 |
| Comparative | H-3 | α | 10 | 0 | 0 | 288 | 327 | 88 | 370 | 391 | 95 |
| example | I-3 | α + B + M | 19 | 40 | 44 | 723 | 838 | 86 | 905 | 957 | 95 |
| | J-3 | α + M | 18 | 0 | 35 | 376 | 437 | 86 | 613 | 654 | 94 |
| | K-3 | α + B + M | 33 | 22 | 23 | 347 | 408 | 85 | 517 | 552 | 94 |
| | L-3 | α + B + M | 10 | 30 | 31 | 387 | 442 | 88 | 537 | 565 | 95 |
| | M-3 | α + B + M | 32 | 22 | 33 | 367 | 431 | 85 | 569 | 616 | 93 |
| | N-3 | α + B + M | 94 | 22 | 24 | 288 | 343 | 84 | 604 | 640 | 94 |
| | O-3 | α + P | 8 | 0 | 0 | 345 | 393 | 88 | 495 | 520 | 95 |

α: Ferrite
B: Bainite
M: Martensite
P: Pearlite
t: Steel pipe thickness
D: Steel pipe outer diameter

In the cases of the invention examples Symbols A-3 to F-3, the steel components were within the ranges specified in the present invention, any of the structures was composed of ferrite and martensite, or ferrite, bainite and martensite, any of the average ferrite grain sizes was not smaller than 20 μm, and the bainite content rates and the martensite content rates were in the preferable range of not more than 15%. The yield ratios (YRs) of the 5%-prestrain specimens were in the range from 83 to 86%.

In the cases of the comparative examples Symbols H-3 to O-3, any of the steel components deviated from the ranges specified in the present invention. The structures were composed of ferrite in the case of Symbol H-3, and of ferrite and pearlite in the case of Symbol O-3. Whereas, in the case of Symbol O-3, pearlite formed because the cooling rate was less than 5° C./sec. in the temperature range of not higher than Ar₁ point+50° C., in the case of Symbol H-3, single ferrite phase formed because the C content was as low as 0.005% in addition to the influence of the low cooling rate similar to the case of Symbol O-3. In the cases other than Symbols K-3, M-3 and N-3, the average ferrite grain sizes were less than 20 μm. This meant that the average ferrite grain sizes reduced because the cooling rates were more than 10° C./sec. up to a temperature of Ar₁ point+50° C. after the end of hot rolling. In any cases of Symbols I-3, J-3, K-3, L-3, M-3 and N-3 where the structures contained martensite and bainite, the bainite content rates and martensite content rates exceeded 15%; the upper limit of the preferable range. This was because the cooling after the end of hot rolling was commenced from a temperature higher than Ar₁ point+50° C. and, as a result, ferrite transformation did not proceed and thus the bainite content rates or the martensite content rates increased. The yield ratios (YRs) of the 5%-prestrain specimens were in the range from 93 to 95%.

The present invention makes it possible to reduce the production cost of a low yield ratio steel pipe by suppressing the Cr content, enhance tensile strength at the ordinary temperature by suppressing the formation of Cr oxides that deteriorate the quality of a weld and raising the upper limit of the C content, and thus obtain a low yield ratio steel pipe.

What is claimed is:

1. A steel pipe having a low yield ratio, characterized in that:
the steel pipe contains, in mass, 0.01% to 0.20% C, 0.05 to 1.0% Si, 0.1% to 2.0% Mn, 0.001% to 0.05% Al, with a balance consisting of Fe and unavoidable impurities, wherein a microstructure of the steel pipe is composed of ferrite and at least one of pearlite and cementite, and wherein an average size of grains of the ferrite in the microstructure is at least 20 μm.

2. The steel pipe according to claim 1, wherein the microstructure contains one of a spheroidized pearlite and a spheroidized cementite.

3. The steel pipe according to claim 2, the average size of grains of one of the pearlite and the cementite is not larger than 20 μm.

4. The steel pipe according to any one of claims 1 to 3, wherein the steel pipe contains, in mass, at least one of 0.01% to 0.5% Nb and 0.001% to 0.01% N.

5. The steel pipe according to claim 1, wherein the steel pipe contains, in mass, at least one of 0.005% to 0.1% Ti and 0.0001% to 0.005% B.

6. The steel pipe according to claim 1, wherein the steel pipe contains, in mass, at least one of 0.01% to 0.5% V, 0.01%to 1% Cu, 0.01% to 1% Ni, 0.01% to 1% Cr and 0.01% to 1% Mo.

7. A steel pipe having a low yield ratio, characterized in that:
the steel pipe contains, in mass, 0.03% to 0.20% C, 0.05% to 1.0% Si, 0.1% to 2.0% Mn, 0.001% to 0.05% Al, 0.01% to 0.5% Nb, 0.001% to 0.01% N, with a balance consisting of Fe and unavoidable impurities, wherein a microstructure of the steel pipe is composed of ferrite and bainite, and wherein an average size of grains of the ferrite in the microstructure is at least 20 μm.

8. The steel pipe according to claim 7, wherein the bainite has a content rate which is, based on a volume fraction, in the range from 1% to 15%.

9. The steel pipe according to claim 7 or 8, wherein the steel pipe contains, in mass, at least one of 0.005% to 0.1% Ti and 0.0001% to 0.005% B.

10. The steel pipe according to claim 7 or 8, wherein the steel pipe contains, in mass, at least one of 0.01% to 0.5% V, 0.01%to 1% Cu, 0.01% to 1% Ni, 0.01% to 1% Cr and 0.01% to 1% Mo.

11. A steel pipe having a low yield ratio, characterized in that:
the steel pipe contains, in mass, 0.03% to 0.20% C, 0.05% to 1.0% Si, 0.1% to 2.0% Mn, 0.001% to 0.05% Al, 0.01% to 0.5% Nb, 0.001% to 0.01% N, with the balance consisting of Fe and unavoidable impurities, wherein a microstructure of the steel pipe is composed of one set of:
ferrite, martensite and bainite, or
ferrite and martensite, and
wherein an average size of grains of the ferrite is at least 20 μm.

12. The steel pipe according to claim 11, wherein the bainite has a content rate that is, based on a volume fraction, in the range from 1% to 15%.

13. The steel pipe according to claim 11, wherein the martensite has a content rate that is, based on a volume fraction, in the range from 1% to 15%.

14. The steel pipe according to any one of claims 11 to 13, wherein the steel pipe contains, in mass, at least one of 0.005% to 0.1% Ti and 0.0001% to 0.005% B.

15. The steel pipe according to any one of claims 11 to 13, wherein the steel pipe contains, in mass, at least one of 0.01% to 0.5% V, 0.01%to 1% Cu, 0.01% to 1% Ni, 0.01% to 1% Cr and 0.01% to 1% Mo.
